(19) United States
(12) Patent Application Publication
(10) Pub. No.: US 2017/0282405 A1
(43) Pub. Date: Oct. 5, 2017

(54) Method for Controlling a Wall Saw System During the Creation of a Separating Cut

(71) Applicant: Hilti Aktiengesellschaft, Schaan (LI)

(72) Inventors: Wilfried Kaneider, Rankweil (AT); Dragan Stevic, Feldkirch-Tosters (AT); Christian Bereuter, Lingenau (AT); Peter Hricko, Buchs (CH)

(73) Assignee: Hilti Aktiengesellschaft, Schaan (LI)

(21) Appl. No.: 15/509,432

(22) PCT Filed: Sep. 2, 2015
(86) PCT No.: PCT/EP2015/069984

§ 371 Date: Mar. 7, 2017

(30) Foreign Application Priority Data
Sep. 8, 2014 (EP) 14003102.2

(51) Int. Cl. B28D 7/00; B28D 1/10; B28D 1/04

(52) U.S. Cl. CPC B28D 7/005; B28D 1/044; B28D 1/10

(57) ABSTRACT

A method for controlling a wall saw system during creation of a separating cut in a workpiece between a first and a second end point is disclosed. The separating cut is performed in a plurality of main cuts. The movement of the saw head is controlled at the end points such that a boundary of the wall saw facing the end point coincides with the end point. In the case of a free end point, the boundary of the wall saw is formed by an upper exit point of the saw blade. In the case of an obstacle, the boundary of the wall saw is formed by the saw blade edge of the saw blade if the processing occurs without the blade guard or by the blade guard edge of the blade guard if the processing occurs with the blade guard.

This application claims the priority of International Application No. PCT/EP2015/069984, filed Sep. 2, 2015, and European Patent Document 14003102.2, filed Sep. 8, 2014, the disclosures of which are expressly incorporated by reference herein.

### BACKGROUND AND SUMMARY OF THE INVENTION

The invention relates to a method for controlling a wall saw system during the creation of a separating cut.

A method for controlling a wall saw system during the creation of a separating cut in a workpiece between a first end point and a second end point is known from EP 1693 173 B1. The wall saw system comprises a guide rail and a wall saw with a saw head, a motorized feed unit that pushes the saw head parallel to a feed direction along the guide rail, and at least one saw blade that is attached to a saw arm of the saw head and driven by a drive motor around a fulcrum. The saw arm is designed to pivot around a swivel axis using a swing motor. Pivoting the saw arm around the swivel axis changes the depth to which the saw blade penetrates into the workpiece. The motorized feed unit comprises a guide block and a feed motor, wherein the saw head is affixed to the guide block and is moved along the guide rail by the feed motor. A sensor system with a pivoting angle sensor and a path sensor is provided to monitor the wall saw system. The pivoting angle sensor measures the instantaneous pivoting angle of the saw arm and the path sensor measures the current position of the saw head on the guide rail. The measured values of the current pivoting angle of the saw head and the current position of the saw head are regularly transmitted to a control unit of the wall saw.

The known method for controlling a wall saw system is divided into a preparatory part and processing of the separating cut controlled by the control unit. In the preparatory part, the operator defines at least the saw blade diameter of the saw blade, the position of the first and second end points in the feed direction, and the final depth of the separating cut; other parameters may be the material of the workpiece being processed and the dimensions of embedded armoring iron. Using the input parameters, the control unit determines for the separating cut a suitable main-cut sequence of main cuts, wherein the main-cut sequence comprises at least a first main cut with a first main-cut angle of the saw arm and a first diameter of the saw blade used as well as a subsequent second main cut with a second main-cut angle of the saw arm and a first diameter of the saw blade used.

After the start of the controlled processing, the saw head is positioned in a start position. In the start position the saw arm is pivoted around the swivel axis in a negative direction of rotation and configured at the negative first main-cut angle. The saw head is moved in a positive feed direction along the guide rail in the direction of the second end point, with the saw arm in a pulling configuration during processing. Before the second end point is reached, the saw head is stopped and backed up sufficiently far in a negative feed direction opposite to the positive feed direction. The saw arm is swiveled in a positive rotational direction opposite to the negative rotational direction out of the negative first main-cut angle to a positive main-cut angle of the saw arm.

In a first variation, the saw arm is swiveled out of the negative first main-cut angle into the positive first main-cut angle and the saw head is moved towards the second end point in the positive feed direction, with the saw arm in a pushing configuration. When the second end point is reached, the feed direction is reversed and the saw head is moved in the negative feed direction to the first end point, with the saw arm in a pulling configuration. Before the first end point the saw head is stopped and backed up sufficiently far in the positive feed direction. The saw arm is swiveled out of the positive first main-cut angle into the negative first main-cut angle and the saw head is moved in the negative feed direction towards the first end point, with the saw arm in a pushing configuration.

In a second variation, the saw arm is swiveled out of the negative first main-cut angle into the positive second main-cut angle and the saw head is moved towards the second end point in the positive feed direction, with the saw arm in a pushing configuration. When the second end point is reached, the feed direction is reversed and the saw head is moved towards the first end point in the negative feed direction, with the saw arm in a pulling configuration.

Before the first end point the saw head is stopped and backed up sufficiently far in the positive feed direction. The saw arm is swiveled out of the negative second main-cut angle into a positive main-cut angle and the saw head is moved towards the first end point in the negative feed direction, with the saw arm in a pushing configuration. If the second main cut is the last main cut, the saw arm is swiveled into the positive second main-cut angle. If a third main cut with a third main-cut angle is to be executed, the saw arm is swiveled out of the negative second main-cut angle into the positive third main-cut angle of the third main cut. The method steps are repeated until the final depth of the separating cut is reached.

The known method for controlling a wall saw system has the disadvantage that the saw head is reversed into a pushing configuration of the saw arm before processing. This reversal only positions the saw head and does not process the workpiece. The time required for positioning extends non-productive time, especially during the creation of short cuts.

The object of the present invention is to develop a method for controlling a wall saw system with a high processing quality in which the non-productive times for positioning the saw head and saw arm are reduced.

This object is achieved, according to the present invention, by the characterizing features of the independent Claim in the method for controlling a wall saw system described above. Beneficial further developments are stated in the dependent Claims.

It is provided by the present invention that the saw head is moved during the processing controlled by the control unit such that a second end point-facing second boundary of the wall saw system coincides with the second end point, with the second boundary of the wall saw formed by a second end point-facing second upper exit point of the saw blade used on the top side of the workpiece, if the second end point does not form an obstacle, by a second end point-facing second saw blade edge of the saw blade used if the second end point does form an obstacle and the processing is performed without a blade guard, and by a second end point-facing second blade guard edge of the blade guard used if the second end point forms an obstacle and the processing is performed with a blade guard.

The invention's method for controlling a wall saw system has the advantage that processing is possible with both a pulling and a pushing saw arm configuration and non-productive times for positioning the saw head are reduced by corresponding position control of the saw head. A narrow cut slit is achieved by the first main cut of the main-cut sequence being executed strictly by a pulling saw arm and the saw blade being guided through the narrow cut slit of the first main cut by a pushing saw arm in the subsequent main cuts. A separating cut in which the saw arm is configured alternatively as pulling and pushing has the advantage that the non-productive times needed for positioning the saw head and swiveling the saw arm are reduced compared to processing with an exclusively pulling saw arm.

It is also preferable before the start of the processing controlled by the control unit to specify a saw arm length of the saw arm that is defined as the distance between the swivel axis of the saw arm and the fulcrum of the saw blade and a distance between the swivel axis and the top of the workpiece. Various parameters must be known to the control unit for controlled processing of a separating cut. These include the saw arm length, which is a fixed apparatus-specific parameter of the wall saw, and the vertical distance between the swivel axis and the surface of the workpiece, which depends on both the geometry of the wall saw and the geometry of the guide rail being used.

Particularly preferable before the start of the controlled processing is also a set first width for a blade guard used during the first main cut and a set second width for a blade guard used during the second main cut, with the first and second width consisting respectively of a first distance between the fulcrum and the first blade guard edge and a second distance between the fulcrum and the second blade guard edge. If an end point forms an obstacle, the position of the saw head is controlled by the obstacle-facing blade guard edge of the blade guard being used. If the blade guard is asymmetrical, the first and second distance between the fulcrum and the blade guard edges are different, while for a symmetrical blade guard the first and second distances between the blade guard edges agree with half the width of the blade guard.

It is preferable that the second upper exit point of the saw blade being used coincides with the second end point when the swivel axis is a distance from the second end point of \sqrt{[h₁·}(D₁−h₁)]+δ·sin(−α₁), where

$${h}_{1} = h ( - {α}_{1} ) = \frac{{D}_{1}}{2} - Δ - δ \cdot cos ( - {α}_{1} )$$

describes the penetration depth of the saw blade being used into the workpiece for the negative first main-cut angle, the second saw blade edge of the saw blade being used coincides with the second end point when the swivel axis is a distance from the second end point of

$$\frac{{D}_{1}}{2} + δ \cdot sin ( - {α}_{1} ) ,$$

and the second blade guard edge of the blade guard being used coincides with the second end point when the swivel axis is a distance from the second end point of B_{1b}+δ·sin(−α₁).

It is particularly preferable to position the saw head in a negative feed direction oriented opposite to the positive feed direction such that the second boundary of the wall saw coincides with the second end point after the pivoting motion of the saw arm into the negative second main-cut angle. In the course of this, after the pivoting motion of the saw arm into the negative second main-cut angle, the second upper exit point of the saw blade being used coincides with the second end point when the swivel axis is a distance from the second end point of \sqrt{[h₂·}(D₂−h₂)]+δ·sin(−α₂), where

$${h}_{2} = h ( - {α}_{2} ) = \frac{{D}_{2}}{2} - Δ - δ \cdot cos ( - {α}_{2} )$$

describes the penetration depth of the saw blade being used into the workpiece for the negative second main-cut angle, the second saw blade edge of the saw blade being used coincides with the second end point when the swivel axis is a distance from the second end point of

$$\frac{{D}_{2}}{2} + δ \cdot sin ( - {α}_{2} ) ,$$

and the second blade guard edge of the blade guard being used coincides with the second end point when the swivel axis is a distance from the second end point of B_{2b}+δ·sin(−α₂).

In a preferable further development, during the controlled processing of the second main cut the saw head is moved such that a first end point-facing first boundary of the wall saw coincides with the first end point, with the first boundary of the wall saw being formed by a first end point-facing first upper exit point of the saw blade being used on the top of the workpiece, if the first end point does not form an obstacle, by a first end point-facing first saw blade edge of the saw blade being used if the first end point does form an obstacle and the processing is performed without a blade guard, and by a first end point-facing first blade guard edge of the blade guard being used if the first end point forms an obstacle and processing is performed with a blade guard.

In a first embodiment, the second main cut is the final main cut of the main-cut sequence and the wall saw is moved to an end position after the second main cut. The number of main cuts depends on, among other things, the specification of the saw blade being used, the hardness of the material, the power and torque of the drive motor for the saw blade, and the final depth of the separating cut.

In a second embodiment, the main-cut sequence indicates a third main cut following the second main cut with a third main-cut angle of the saw arm, a third diameter of the saw blade being used, and a third width of the blade guard being used with a first and second distance, with the saw arm being configured in a pulling configuration for the third cut and the saw head moving in the positive feed direction.

The saw head is positioned in the positive feed direction such that the first boundary of the wall saw coincides with the first end point after the pivoting motion of the saw arm in the negative third main-cut angle.

In the course of this, after the pivoting motion of the saw arm in the negative third main-cut angle, the first upper exit point of the saw blade being used coincides with the first end point when the swivel axis is a distance from the first end point of \sqrt{[h₃·}(D₃−h₃)]−δ·sin(−α₃), where

$${h}_{3} = h ( - {α}_{3} ) = \frac{{D}_{3}}{2} - Δ - δ \cdot cos ( - {α}_{3} )$$

describes the penetration depth of the saw blade being used into the workpiece for the negative third main-cut angle, the first saw blade edge of the saw blade being used coincides with the first end point when the swivel axis is a distance from the first end point of

$$\frac{{D}_{3}}{2} - δ \cdot sin ( - {α}_{3} ) ,$$

and the first blade guard edge of the blade guard being used coincides with the first end point when the swivel axis is a distance from the first end point of B₃ₐ−δ·sin(−α₃).

The first and second main cut are executed with a saw blade and a blade guard or alternately the first main cut is executed by a first saw blade and a first blade guard, with the first saw blade having a first saw blade diameter and the first blade guard having a first blade guard width, and the second main cut is executed with a second saw blade and a second blade guard, with the second saw blade having a second saw blade diameter and the second blade guard having a second blade guard width. The number of main cuts and the saw blade diameters used for them depend on, among other things, the specification of the saw blade, the hardness of the material, the power and torque of the drive motor for the saw blade, and the final depth of the separating cut.

In a preferable embodiment, the first main cut of the main-cut sequence is a precut and, after the start of processing controlled by the control unit, the saw head is positioned in a start position parallel to the feed direction, where in the start position the first end point-facing first boundary of the wall system coincides with the first end point after the pivoting motion into the negative first main-cut angle, where the first boundary of the wall system is formed by the first upper exit point of the saw blade being used on the top of the workpiece, if the first end point does not form an obstacle, by the first saw blade edge of the saw blade being used if the first end point does form an obstacle and processing is performed without a blade guard, and by the first blade guard edge of the blade guard being used if the first end point forms an obstacle and processing is performed with a blade guard.

It is particularly preferable for the first upper exit point to coincide with the first end point in the start position when the swivel axis is a distance from the first end point of \sqrt{[h₁·}(D₁−h₁)]−δ·sin(−α₁), where

$${h}_{1} = h ( - {α}_{1} , {D}_{1} ) = \frac{{D}_{1}}{2} - Δ - δ \cdot cos ( - {α}_{1} )$$

describes the penetration depth of the saw blade being used into the workpiece for the negative first main-cut angle, the first saw blade edge of the saw blade being used coincides with the first end point when the swivel axis is a distance from the first end point of

$$\frac{{D}_{1}}{2} - δ \cdot sin ( - {α}_{1} ) ,$$

and the first blade guard edge of the blade guard being used coincides with the first end point when the swivel axis is a distance from the first end point of B₁ₐ−δ·sin(−α₁).

The saw head is moved with the saw arm tilted to the negative first main-cut angle in the positive feed direction and the first main cut of the separating cut is executed with a pulling-configured saw arm. The pulling configuration of the saw arm creates a narrow cut slit that acts as a guide for the pushing-configured saw arm in the subsequent main cuts.

In an alternative preferred embodiment, the main-cut sequence comprises a precut executed before the first main cut with a zeroth main-cut angle of the saw arm, a zeroth average of the saw blade being used, and a zeroth width of the blade guard being used with a first and second distance, with the saw arm in a pulling configuration and the saw head moving in the negative feed direction in the precut. The pulling configuration of the saw arm creates a narrow cut slit that acts as a guide for the pushing-configured saw arm in the subsequent main cuts.

After the start of processing controlled by the control unit, the saw head is positioned in a start position parallel to the feed direction for the precut, where in the start position the second end point-facing second boundary of the wall saw coincides with the second end point after the pivoting motion into the positive zeroth main-cut angle. After the pivoting motion into the positive zeroth main-cut angle, the second upper exit point of the saw blade being used coincides with the second end point when the swivel axis is a distance from the second end point (E₂) of \sqrt{[h₀}(D₀−h₀)]+δ·sin(+α₀), where

$${h}_{0} = h ( + {α}_{0} , {D}_{0} ) = \frac{{D}_{0}}{2} - Δ - δ .$$

cos(+α₀) describes the penetration depth of the saw blade being used into the workpiece for the positive zeroth main-cut angle, the second saw blade edge of the saw blade being used coincides with the second end point when the swivel axis is a distance from the second end point of

$$\frac{{D}_{0}}{2} + δ \cdot sin ( + {α}_{0} ) ,$$

and the second blade guard edge of the blade guard being used coincides with the second end point when the swivel axis is a distance from the second end point of B_{0b}+δ·sin(+α₀).

The saw head is moved in the negative feed direction with the saw arm tilted to the positive zeroth main-cut angle. The puffing-configured saw arm creates a narrow cut slit that acts as a guide for the pushing-configured saw arm in subsequent main cuts.

The saw head is moved such that the first boundary of the wall saw coincides with the first end point, with the first boundary of the wall saw formed by the first upper exit point of the saw blade being used on the top of the workpiece, if the first end point does not form an obstacle, by the first saw blade edge of the saw blade being used, if the first end point does form an obstacle and processing is performed without a blade guard, and by the first blade guard edge of the blade guard being used if the first end point forms an obstacle and processing is performed with a blade guard. The first upper exit point of the saw blade being used coincides with the first end point when the swivel axis is a distance from the first end point of \sqrt{[h₀·}(D₀−h₀)]−δ·sin(+α₀), where

$${h}_{0} = h ( + {α}_{0} , {D}_{0} ) = \frac{{D}_{0}}{2} - Δ - δ \cdot cos ( + {α}_{0} )$$

describes the penetration depth of the saw blade being used into the workpiece for the positive zeroth main-cut angle, the first saw blade edge of the saw blade being used coincides with the first end point when the swivel axis is a distance from the first end point of

$$\frac{{D}_{0}}{2} - δ \cdot sin ( + {α}_{0} ) ,$$

and the first blade guard edge of the blade guard being used coincides with the first end point when the swivel axis is a distance from the first end point of B₀ₐ−δ·sin(+α₀).

The switch from the precut (zeroth main cut) to the first main cut can be performed in different ways. The variations are distinguished by how the residue of the precut is removed. In a first variation, the material in the precut is fully removed. In a second variation, the saw arm is pivoted into the negative first main-cut angle before reaching the first end point and the residue is fully or at least mostly removed. A third variation omits the removal and pivots the saw arm directly out of the positive zeroth pivoting angle into the negative first main-cut angle.

In the first variation, the saw head is moved so that after the pivoting motion of the saw arm into the negative zeroth main-cut angle, the first boundary of the wall saw coincides with the first end point, where the first upper exit, point of the saw blade being used coincides with the first end point when the swivel axis is a distance from the first end point of \sqrt{[h₀·}(D₀−h₀)]−δ·sin(−α₀), where

$${h}_{0} = h ( - {α}_{0} , {D}_{0} ) = \frac{{D}_{0}}{2} - Δ - δ \cdot cos ( - {α}_{0} )$$

describes the penetration depth of the saw blade being used into the workpiece for the negative zeroth main-cut angle, the first saw blade edge of the saw blade being used coincides with the first end point when the swivel axis is a distance from the first end point of

$$\frac{{D}_{0}}{2} - δ \cdot sin ( - {α}_{0} ) ,$$

and the first blade guard edge of the blade guard being used coincides with the first end point when the swivel axis is a distance from the first end point of B₀ₐ−δ·sin(−α₀).

After the saw arm is pivoted, the saw head is moved in the positive feed direction for a path length of at least 2δ·| sin(−α₀)| and the saw head is then positioned so that after the pivoting motion of the saw arm into the negative first main-cut angle, the first boundary of the wall saw coincides with the first end point, where the first upper exit point of the saw blade being used coincides with the first end point when the swivel axis is a distance from the first end point of \sqrt{[h₁·}(D₁−h₁)]−δ sin(−α₁), where

$${h}_{1} = h ( - {α}_{1} , {D}_{1} ) = \frac{{D}_{1}}{2} - Δ - δ \cdot cos ( - {α}_{1} )$$

describes the penetration depth of the saw blade being used into the workpiece for the negative first main-cut angle with the first diameter, the first saw blade edge of the saw blade being used coincides with the first end point when the swivel axis is a distance from the first end point of

$$\frac{{D}_{1}}{2} + δ \cdot sin ( - {α}_{1} ) ,$$

and the first blade guard edge of the blade guard being used coincides with the first end point when the swivel axis is a distance from the first end point of B_{1α}+δ sin(−α₁).

In the second variation, the saw head is moved in the positive feed direction such that after the pivoting motion of the saw arm into the negative first main-cut angle, the first boundary of the wall saw coincides with the first end point, where the first upper exit point of the saw blade being used coincides with the first end point when the swivel axis is a distance from the first end point of \sqrt{[h₁·}(D₁−h₁)]+δ sin(−α₁), where

$${h}_{1} = h ( - {α}_{1} , {D}_{1} ) = \frac{{D}_{1}}{2} - Δ - δ .$$

cos(−α₁) describes the penetration depth of the saw blade being used into the workpiece for the negative first main-cut angle with the first diameter, the first saw blade edge of the saw blade being used coincides with the first end point when the swivel axis is a distance from the first end point of

$$\frac{{D}_{1}}{2} - δ \cdot sin ( - {α}_{1} ) ,$$

and the first blade guard edge of the blade guard being used coincides with the first end point when the swivel axis is a distance from the first end point of B₁ₐ−δ·sin(−α₁).

In the third variation, the saw head is moved so that after the pivoting motion of the saw head into the negative first main-cut angle, the first boundary of the wall saw coincides with the first end point, where the first upper exit point of the saw blade being used coincides with the first end point when the swivel axis is a distance from the first end point of \sqrt{[h₁·}(D₁−h₁)]−δ sin(−α₁), where

$${h}_{1} = h ( - {α}_{1} , {D}_{1} ) = \frac{{D}_{1}}{2} - Δ - δ \cdot cos ( - {α}_{1} )$$

describes the penetration depth of the saw blade being used into the workpiece for the negative first main-cut angle, the first saw blade edge of the saw blade being used coincides with the first end point when the swivel axis is a distance from the first end point of

$$\frac{{D}_{1}}{2} - δ \cdot sin ( - {α}_{1} ) ,$$

and the first blade guard edge of the blade guard being used coincides with the first end point when the swivel axis is a distance from the first end point of B_{1α}·δ·sin(−α₁).

The invented method applies to all main cuts in which the main-cut angle is less than or equal to a critical pivoting angle. The critical pivoting angle is ±90° if the end point forms an obstacle and the critical pivoting angle is 180°−arc cos [Δ/(δ·D/s)] when the end point forms a free end point without obstacle.

Exemplary embodiments of the invention are described below using the drawings. This does not necessarily display the exemplary embodiments to scale; rather, the drawings, where used to clarify, is executed in schematic and/or slightly distorted form. For supplements to the teachings directly evident from the drawings, please refer to the relevant state of the art. It must be taken into account that many modifications and changes to the form and detail of an embodiment can be performed without departing from the general idea of the invention. The characterizing features of the invention disclosed in the specification, the drawing, and the Claims can be crucial to the further development of the invention both individually and in any combination. In addition, all combinations of at least two of the characterizing features disclosed in the specification, the drawings, and/or the Claims fall within the scope of the invention. The general idea of the invention is not limited to the exact form or the details or the preferred embodiment shown and described below or limited to an object that would be limited in comparison to the object claimed in the Claims. Where ranges of measurements are given, values that fall within the stated limits are also intended to be disclosed as threshold values and to be freely usable and claimable. In the interests of simplicity, the same reference symbols are used below for identical or similar parts or parts with identical or similar functions.

### BRIEF DESCRIPTION OF THE DRAWINGS

FIG. 1 illustrates a wall saw system with one guide rail and one wall saw;

FIGS. 2A, B illustrate processing of a separating cut between a first and second free end point without an obstacle;

FIGS. 3A; B illustrate processing of a separating cut between a first and second obstacle with a saw blade that is not enclosed by a blade guard;

FIGS. 4A, B illustrate processing of a separating cut between a first and second obstacle with a saw blade enclosed by a blade guard;

FIGS. 5A-L illustrate the wall saw system of FIG. 1 during creation of a separating cut between a first obstacle and a second free end point without obstacle.

### DETAILED DESCRIPTION OF THE DRAWINGS

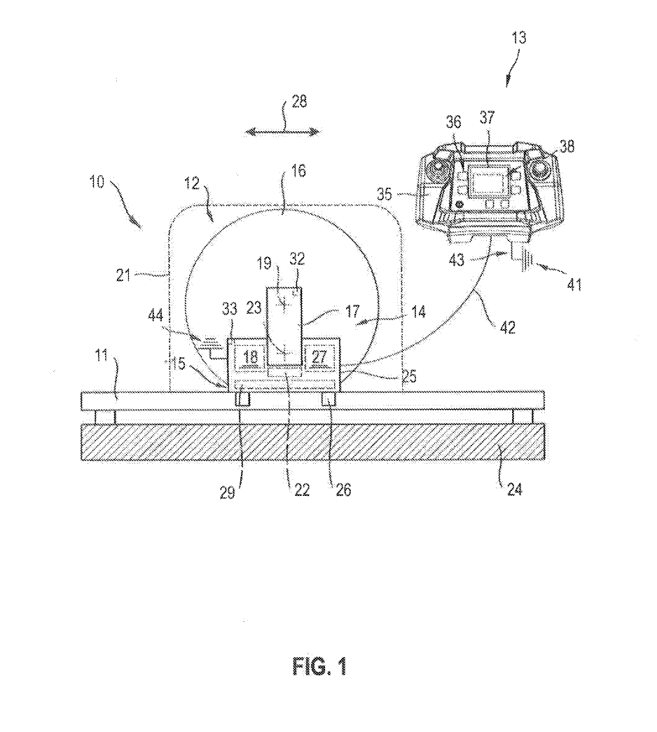

FIG. 1 shows a wall saw system 10 with a guide rail 11, a tool instrument 12 configured to be moveable on the guide rail 11, and a remote control 13. The tool instrument is designed as wall saw 12 and comprises a processing unit 14 and a motorized feed unit 15. The processing unit is designed as saw head 14 and comprises a processing tool 16 designed as a saw blade that is attached a saw arm 17 and driven by a drive motor 18 around a fulcrum 19.

To protect the operator, the saw blade 16 is enclosed by a blade guard 21 that is attached to saw arm 17 by a blade guard holder. Saw arm 17 is designed to be pivoted by a swing motor 22 around a swivel axis 23. The pivoting angle α of saw arm 17 determines with a saw blade diameter D of saw blade 16 how deep saw blade 16 dips into a workpiece being processed 24. The drive motor 18 and the swing motor 22 are configured to be in a tool casing 25. The motorized feed unit 15 comprises a guide block 26 and a feed motor 27, also placed in tool casing 25 in the exemplary embodiment. Saw head 14 is attached to guide block 26 and designed to be moved along guide rail 11 by feed motor 27 in a feed direction 28. Tool casing 25 contains both the motors 19, 22, 27 and a control unit 29 for controlling saw head 14 and the motorized feed unit 15.

To monitor the wall saw system 10 and the processing process, a sensor installation with multiple sensor elements is provided. A first sensor element 32 is designed as a pivoting angle sensor and a second sensor element 33 as a path sensor. The pivoting angle sensor 32 measures the current pivoting angle of the saw arm 17 and the path sensor 33 measures the current position of the saw head 14 on the guide rail 11.

The measurements are transmitted by the pivoting angle sensor 32 and the path sensor 33 to the control unit 29 and used to control the wall saw 12.

The remote control 13 comprises a tool casing 35, an input system 36, a display system 37, and a control unit 38 placed inside tool casing 35. The control unit 38 transforms the inputs of input system 36 into control commands and data that are transmitted via a first communication link to the wall saw 12. The first communication link is designed as a wire- and cable-less communication link 41 or as communication cable 42. The wire- and cable-less communication link is designed in the exemplary embodiment as a radio link 41, which is created between a first radio unit 43 on the remote control 13 and a second radio unit 44 on the tool instrument 12. Alternately, the wire- and cable-less communication link 41 can be designed in the form of an infrared, Bluetooth, AVIAN or Wi-Fi link.

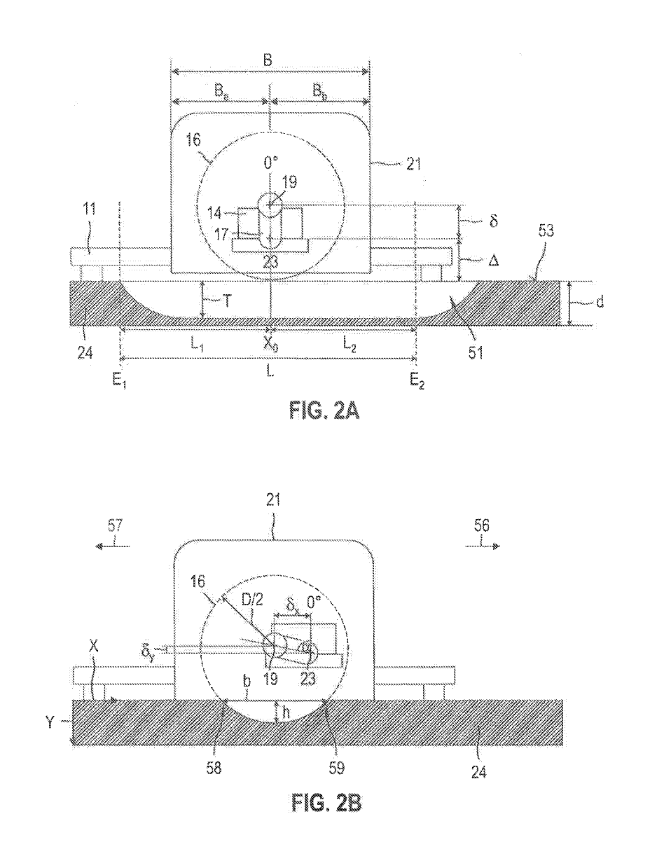

FIGS. 2A, B show the guide rail 11 and the wall saw 12 of the wall saw system 10 of FIG. 1 during the creation of a separating cut 51 in workpiece 24 of workpiece thickness d. The separating cut 51 has a final depth T and runs in feed direction 28 between a first end point E₁ and a second end point E₂. The X direction is defined to be a direction parallel to the feed direction 28, with the positive X direction oriented from the first end point E₁ to the second end point E₂, and the Y direction is defined to be a direction perpendicular to the X direction into the depth of the workpiece 24.

The end point of a separating cut can be defined as a free end point without obstacle or as an obstacle. Both end points can be defined as free end points without obstacle, both can be defined as an Obstacle, or one end point can be defined as a free end point and the other end point as an obstacle. An overlap can be allowed at a free end point without Obstacle. The overlap allows the cut depth at the end point to reach the final depth T of the separating cut. In the exemplary embodiment of FIGS. 2A, B, the end points E₁, E₂ form free end points without obstacle, with no overlap allowed at the free first end point E₁ and an overlap occurring at the second end point E).

FIG. 2A shows the saw head 14 in an assembly position Xₒ and the saw arm 17 in a base position of 0°. The operator positions the saw head 14 on the guide rail 11 in assembly position X₀ using the guide block 26. The assembly position X₀ of the saw head 14 is located between the first and second end point E₁, E₂ and is determined by the position of the swivel axis 23 in feed direction 28. The position of the swivel axis 23 is particularly suitable to be reference position X_{ref} for the position monitoring of saw head 14 and the control of wall saw 12, as the X position of the swivel axis 23 also remains unchanged during the pivoting motion of saw arm 17, Alternately, another X position on the saw head 14 can be set as the reference position; in this case, the distance in the X direction to the swivel axis 23 must also be known.

The X positions of the first and second end points E₁, E₂ are determined in the exemplary embodiment by inputting partial lengths. The distance between the assembly position X₀ and the first end point E₁ defines a first partial length L₁ and the distance between assembly position X₀ and the second end point E₂ a second partial length L₂. Alternately, the X positions of end points E₁, E₂ can be determined by inputting a partial length (L₁ or L₂) and a total length L as the distance between the end points E₁, E₂.

The separating cut 51 is created in multiple partial cuts until the desired final depth T is reached. The partial cuts between the first and second end point E₁, E₂ are defined as main cuts and the cut sequence of the main cuts as the main-cut sequence. Additional edge processing can be performed at the end points of the separating cut, which is called obstacle processing if there is an obstacle and overlap processing if there is a free end point with overlaps.

The main-cut sequence can be determined by the operator, or the control unit of the wall saw system sets the main-cut sequence depending on several limiting conditions. Usually the first main cut, also called a pre-cut, is executed with a reduced cut depth and reduced drive motor power to avoid polishing the saw blade. The other main cuts are generally executed with the same cut depth, but can also have differing cut depths. The limiting conditions usually set by the operator include the cut depth of the pre-cut, the power of the pre-cut, and the maximum cut depth of the other main cuts. The control unit can determine the main-cut sequence from these limiting conditions.

The main cuts of a separating cut are executed with one saw blade diameter or with two or more saw blade diameters. If multiple saw blades are being used, processing generally begins with the smallest saw blade diameter. In order to allow saw blade 16 to be mounted on saw arm 17, saw blade 16 must be configured in the base position of saw arm 17 above workpiece 24. Whether this limiting condition is met depends on two apparatus-specific parameters of the wall saw system 10, firstly on a vertical distance Δ between the swivel axis 23 of saw arm 17 and a top side 53 of the workpiece 24, and secondly on a saw arm length δ of saw arm 17, defined as the distance between the fulcrum 19 of saw blade 16 and the swivel axis 23 of saw arm 17. If the total of these two apparatus-specific parameters is larger than half the saw blade diameter D/2, the saw blade 16 is configured in the base position above workpiece 24. The saw arm length δ is a fixed apparatus-specific parameter of wall saw 12, while the vertical distance Δ between the swivel axis 23 and the surface 53 depends on both the geometry of wall saw 12 and the geometry of the guide rail 11 being used.

Saw blade 16 is attached to a flange on saw arm 17 and is driven by drive motor 18 around fulcrum 19 during saw operation. In the base position of saw arm 17, shown in FIG. 2A, the pivoting angle is 0° and fulcrum 19 of saw blade 16 lies in depth direction 52 above the swivel axis 23, Saw blade 16 is moved by a pivoting motion of saw arm 17 around swivel axis 23 out of the base position at 0° into workpiece 24. During the pivoting motion of saw arm 17, saw blade 16 is driven by drive motor 18 around fulcrum 19.

To protect the operator, saw blade 17 should be enclosed by blade guard 21 during operation. The wall saw 12 is operated with a blade guard 21 or without a blade guard 21. As an example, disassembly of blade guard. 21 may be stipulated for processing of the separating cut in the region of end points E₁, E₂. If different saw blade diameters are used to process the separating cut, different blade guards with corresponding blade guard widths are typically used.

FIG. 2B shows saw arm 17, which is tilted in a negative rotational direction 54 at a negative pivoting angle −α. Saw arm 17 is adjustable in the negative rotational direction 54 between pivoting angles from 0° to −180° and in a positive rotational direction 55, opposite to the negative rotational direction 54, between pivoting angles from 0° to +180″. The configuration of saw arm 17 shown in FIG. 2B is described as a pulling configuration when the saw head 14 is moved in a positive feed direction 56. If saw head 14 is moved in a negative feed direction 57, opposite to the positive feed direction 56, the configuration of saw arm 17 is described as pushing.

The maximum penetration depth of saw blade 16 into workpiece 24 is reached at a pivoting angle of ±180°. The pivoting motion of saw arm 17 around swivel axis 23 displaces the position of fulcrum 19 in the X direction and Y direction. The displacement of fulcrum 19 depends on the saw arm length δ and the pivoting angle α of saw arm 17. The displacement path δₓ in the X direction is δ·sin(±ct) and the displacement path δ_{y} in the Y direction is δ·cos(±α).

Saw blade 16 creates in workpiece 24 a cutting wedge in the form of a circle segment with a height h and a width b. The height h of the circle segment is equal to the penetration depth of saw blade 16 into the workpiece 24. For the penetration depth h, the relation is D/2=h+Δ+δ·cos(α), where D is the saw blade diameter, h is the penetration depth of saw blade 16, Δ is the perpendicular distance between the swivel axis 23 and the top side 53 of the workpiece 24, δ is the saw arm length, and a is the first pivoting angle, and for the width b the relationship is b²=D/2·8h−4h²=4Dh−4h²=4h·(D−h), where h is the penetration depth of saw blade 16 into the workpiece 24 and D is the saw blade diameter.

The control of wall saw 12 during the separating cut depends on whether the end points are defined as obstacles and, if there is an obstacle, whether processing is performed with a blade guard 21 or without a blade guard 21. For a free end point without obstacle, control of wall saw 12 in the invented method is performed through upper exit points of saw blade 16 on the top side 53 of workpiece 24. The upper exit points of saw blade 16 can be calculated from the reference position X_{ref} of the swivel axis 23 in the X direction, the displacement path δₓ of fulcrum 19 in the X direction, and the width b. An upper exit point facing the first end point E₁ is called the first upper exit point 58 and an upper exit point facing the second end point E₂ is called the second upper exit point 59. For the first upper exit point 58, X(58)=X_{ref}+δₓ−b/2, and for the second upper exit point 59, X(59)=X_{ref}+δₓ+b/2, where b=\sqrt{[h·(D−h)]} and h=h(α, D).

If the end points E₁, E₂ are defined as obstacles, running over the end points E₁, E₂ with wall saw 12 is not possible. In this case, control of wall saw 12 in the invented method is performed through the reference position X_{Ref} of swivel axis 23 and the boundary of wall saw 12. Processing without a blade guard 21 and processing with a blade guard 21 are differentiated.

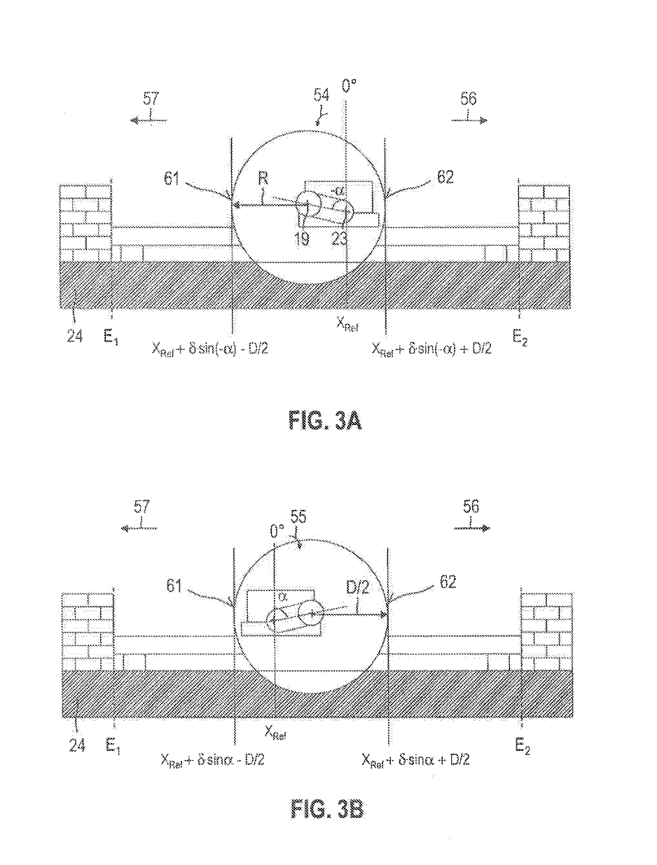

FIGS. 3A, B show the wall saw system 10 during creation of a separating cut between the first end point E₁ and the second end point E₂, which are defined as obstacles, with processing performed without a blade guard 21. In processing without a blade guard 21, a first saw blade edge 61, which faces the first end point E₁, and a second saw blade edge 62, which faces the second end point E₂, form the boundary of wall saw 12.

The X positions of the first and second saw blade edge 61, 62 in the X direction can be calculated from the reference position X_{Ref} of swivel axis 23, the displacement path δₓ of fulcrum 19, and the saw blade diameter D. FIG. 3A shows wall saw 12 with saw arm 17 tilted in the negative rotational direction 54 at a negative pivoting angle −α (0° to 180°). For the first saw blade edge 61, X(61)=X_{Ref}+δ·sin(−α)−D/2 and for the second saw blade edge 62, X(62)=X_{Ref}+δ·sin(−α)+D/2. FIG. 3B shows wall saw 12 with saw arm 17 tilted in the positive rotational direction 55 at a positive pivoting angle α (0° to +180°). For the first saw blade edge 61, X(61)=X_{Ref}+δ·sin(α)−D/2 and for the second saw blade edge 62, X(62)=X_{Ref}+δ·sin(α)+D/2.

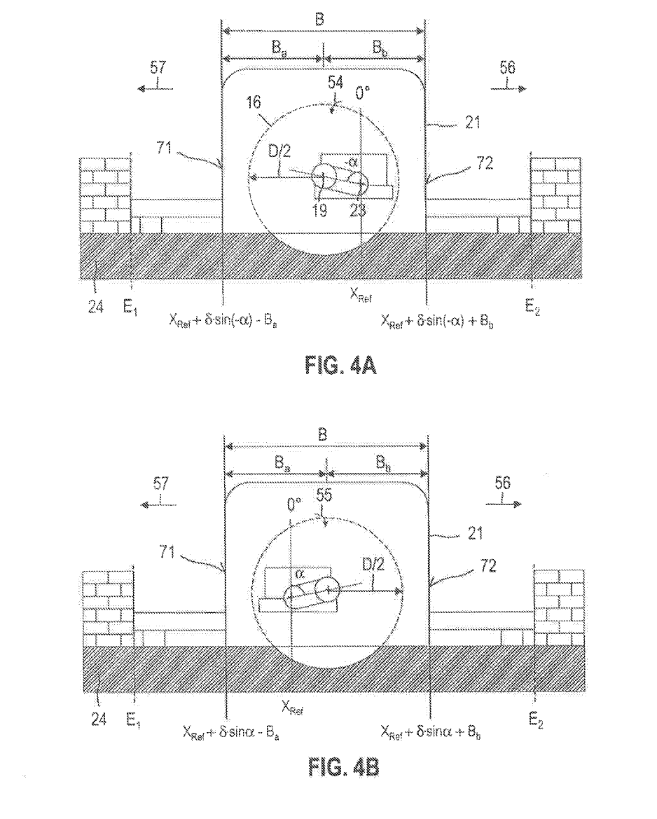

FIGS. 4A, B show the wall saw system 10 during the creation of a separating cut between the first end point E₁ and the second end point E₂, which are defined as obstacles, such that processing is performed with a blade guard 21, For processing without a blade guard 21, a first blade guard edge 71, which faces the first end point E₁, and a second blade guard edge 72, which faces the second end point E₂, form the boundary of wall saw 12.

The X positions of the first and second blade guard edge 71, 72 in the X direction can be calculated from the reference position X_{Ref} of swivel axis 23, the displacement path δₓ of fulcrum 19, and the blade guard width B. FIG. 4A shows wall saw 12 with saw arm 17 tilted at a negative pivoting angle −α (0° to −180°) and the assembled blade guard 21 with a blade guard with B. If the blade guard is asymmetrical, then before controlled processing starts the distances between fulcrum 19 and the blade guard edges 71, 72 are determined, with the distance to the first blade guard edge 71 designated the first distance Bₐ and the distance to the second blade guard edge 72 designated the second distance B_{b}.

For the first blade guard edge 71, X(71)=X_{Ref}+δ·sin(α)−Bₐ and for the second blade guard edge 72, X(72)=X_{Ref}+δ·sin(α)+B_{b}. FIG. 4B shows wall saw 12 with saw arm 17 tilted at a positive pivoting angle α (0° to +180°) and the assembled blade guard 21 of blade guard with B. For the first blade guard edge 71, X(71)=X_{Ref}+δ·sin(α)−Bₐ and for the second blade guard edge 72, X(72) X_{Ref}+δ·sin(α)+B_{b}.

FIGS. 2A, B show a separating cut between end points E₁, E₂ defined as free end points without obstacle, and FIGS. 3A, B and 4A, B show a separating cut between two end points E₁, E₂, defined as obstacles. In practice, separating cuts can exist in which one end point is defined as an Obstacle and the other end point is a free end point without obstacle; the wall saw controlling is performed through the upper exit point of the saw blade for the free end point and through the saw blade edge (processing without a blade guard 21) or the blade guard edge (processing with a blade guard 21) for the obstacle.

The first upper exit point 58, the first saw blade edge 61, and the first blade guard edge 71 are consolidated under the term “first boundary” of wall saw 12 and the second upper exit point 59, the second saw blade edge 62, and the second blade guard edge 72 are consolidated under the term “second boundary.”

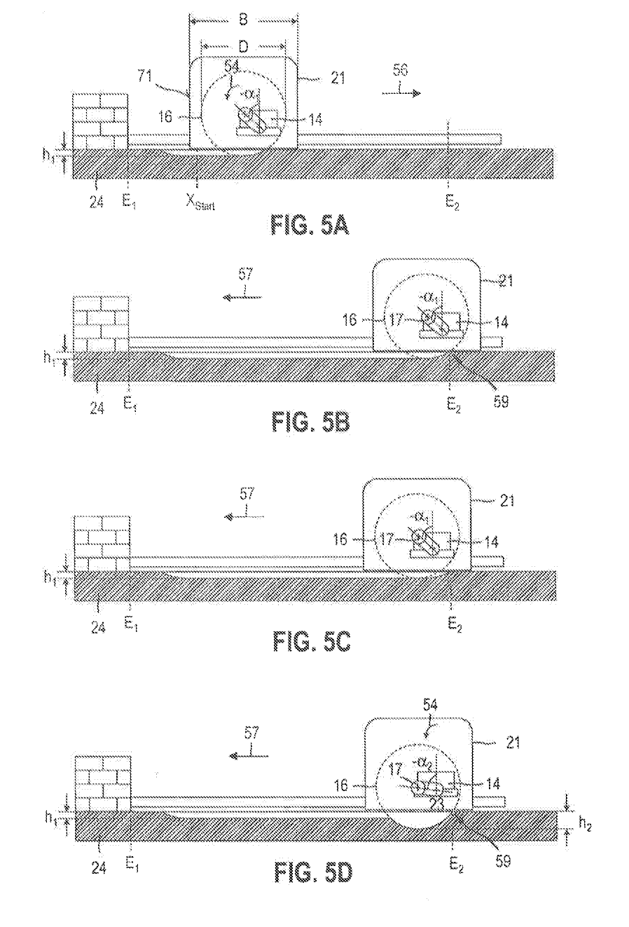

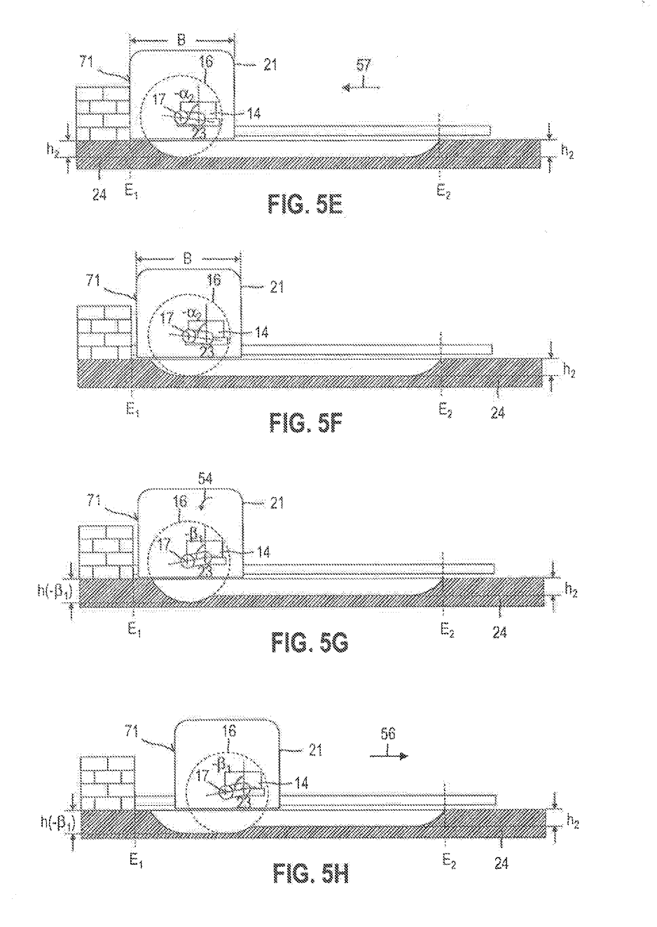

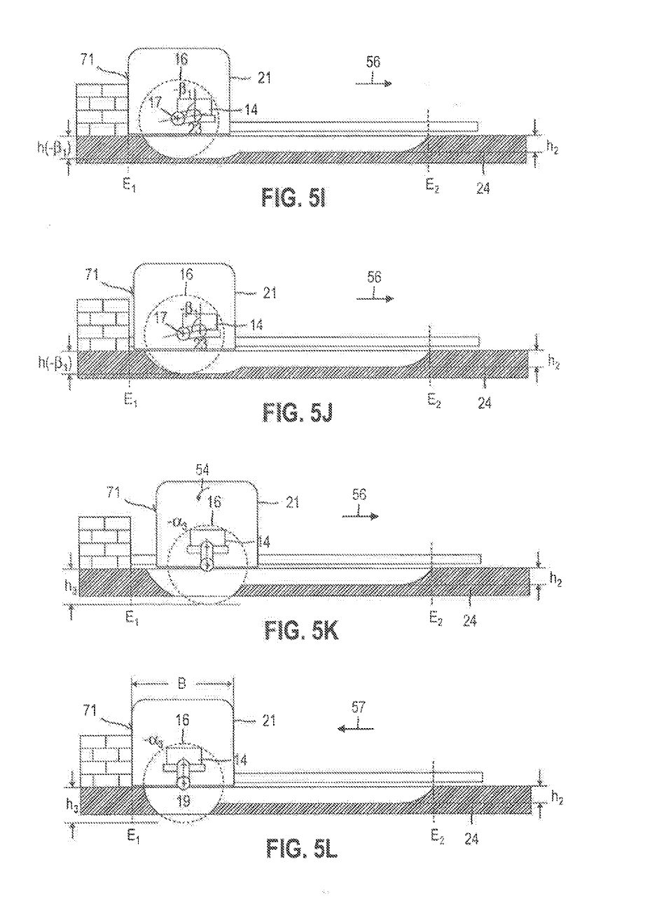

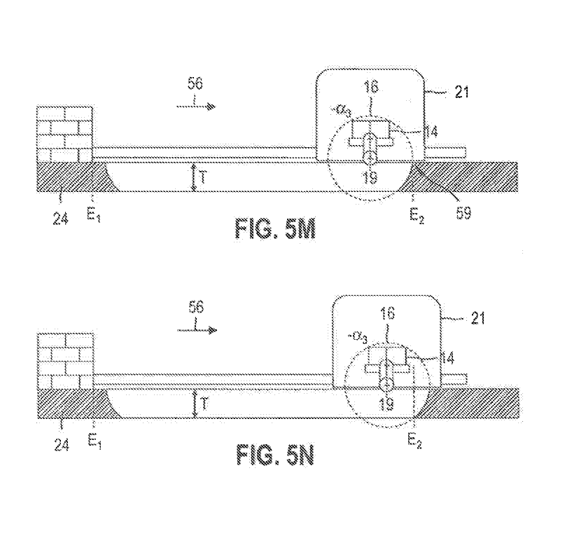

FIGS. 5A-L show the wall saw system 10 of FIG. 1 with guide rail 11 and wall saw 12 during creation of a separating cut of final depth Tin workpiece 24 between the first end point E₁, which is an obstacle, and a second end point E₂, which is a free end point without obstacle.

The separating cut is processed with the help of the invented method for controlling a wall saw system. The separating cut is created by a main-cut sequence of multiple main cuts until the desired final depth T is reached. The main-cut sequence comprises a first main cut with a first main-cut angle α₁ of saw arm 17, a first diameter D₁ and a first penetration depth h₁ of the saw blade being used, a second main cut with a second main-cut angle α₂ of saw arm 17, a second diameter D₂ and a second penetration depth h₂ of the saw blade being used, and a third main cut with a third main-cut angle α₃ of saw arm 17, a third diameter D₃ and a third penetration depth h₃ of the saw blade being used.

In the exemplary embodiment, the first, second, and third main cuts are performed by saw blade 16 with saw blade diameter D and by blade guard. 21 with a blade guard width B. The diameters D₁, D₂, D₃ of the main cuts correspond to the saw blade diameter D of saw blade 16; likewise, the widths B₁, B₂, B₃ of the main cuts correspond to the blade guard width of blade guard 21.

In the invented method, the main cuts are performed with a saw arm 17 that is configured to be alternately pulling and pushing. The pulling configuration of saw arm 17 allows stable guidance of the saw blade during processing and a narrow cut slit. A separating cut in which saw arm 17 is configured to be alternately pulling and pushing has the advantage that the non-productive times needed to position saw head 14 and pivot saw arm 17 are reduced compared to processing with saw arm 17 configured to be exclusively pulling. In the exemplary embodiment, saw head 14 is moved in the first and third main cut with a pulling-configured saw arm 17 in positive feed direction 56; in the second main cut in between, saw head 14 is moved with a pushing-configured saw arm 17 in negative feed direction 57. Saw arm 17 is configured in negative rotational direction 54 in all three main cuts.

The processing of the separating cut begins at the first end point E₁. After the start of the invented method, saw head 14 is positioned in a start position X_{Start} in which the swivel axis 23 is a distance from the first end point of \sqrt{[h₁·}(D₁−h₁)]−δ·sin (−α₁), where

$${h}_{1} = h ( - {α}_{1} , {D}_{1} ) = \frac{{D}_{1}}{2} - Δ - δ \cdot cos ( - {α}_{1} )$$

describes the penetration depth of the saw blade being used into the workpiece 24 at a negative first main-cut angle −α₁ with the first diameter D₁, which corresponds to the saw blade diameter D. In start position X_{Start}, saw arm 17 is pivoted out of the base position at 0° in the negative rotational direction 54 into the negative first main-cut angle −α₁. After the pivoting motion into the negative first main-cut angle −α₁, the first blade guard edge 71 of the blade guard 21 borders on the obstacle at first end point. Then saw head 14 is moved 56 with saw arm 17 tilted to the negative first main-cut angle −α₁ and the rotating saw blade 16 in the positive feed direction (FIG. 5i\). During the feed motion, the position of saw head 14 is regularly measured by the path sensor 33.

The feed motion of saw head 14 is stopped when the swivel axis 23 is a distance from the second end point E₂ of \sqrt{[h₁·}(D₁−h₁)]−δ·sin (−α₁), where

$${h}_{1} = h ( - {α}_{1} , {D}_{1} ) = \frac{{D}_{1}}{2} - Δ - δ \cdot cos ( - {α}_{1} )$$

describes the penetration depth of the saw blade 16 being used into the workpiece 24 for the negative first main-cut angle −α₁ with the first diameter D₁, which corresponds to the saw blade diameter D. In this position, the second upper exit point 59 of saw blade 16, which faces the second end point E₂, coincides with the second end point E₂, and the first main cut is ended (FIG. 5B).

For the second main cut, saw head 14 is positioned in the feed direction 28 such that the swivel axis 23 is a distance from the second end point E₂ of \sqrt{[h₁·}(D₁−h₁)]−δ·sin (−α₂), where

$${h}_{2} = h ( - {α}_{2} , {D}_{2} ) = \frac{{D}_{2}}{2} - Δ - δ \cdot cos ( - {α}_{2} )$$

describes the penetration depth of the saw blade 16 being used into the workpiece 24 for the negative second main-cut angle −α₂ with the second diameter D₉, which corresponds to the saw blade diameter 1) (FIG. 5C). In this position, saw arm 17 is pivoted out of the negative first main-cut angle as into the negative second main-cut angle −α₂ (FIG. 5D). In the positioning in FIG. 5C, the distance is set so that the second upper exit point 59 of saw blade 16, which faces the second end point E₂, coincides with the second end point E₂ after the pivoting motion of saw arm 17 into the negative second main-cut angle −α₂.

Saw head 14 is moved in the negative feed direction 57 to the first end point E₁; the position of saw head 14 is regularly measured by the path sensor 33 during the feed motion. The feed motion of saw head 14 is stopped when the swivel axis 23 is a distance from the first end point E₁ of B/2−δ·sin(−α₂). In this position, the first blade guard edge 71 of blade guard 21 borders on the obstacle at the first end point E₁ and the second main cut is ended (FIG. 5E).

In the exemplary embodiment, the pivoting motion from the negative second main-cut angle −α₂ into the negative third main-cut angle −α₃ is performed in two steps with a first intermediate angle −β₁. The division of the pivoting motion into at least two steps reduces the risk that saw blade 16 will be polished. A smaller pivoting angle leads to reduction of the arc length of the saw blade that is in contact with the workpiece.

In the exemplary embodiment, the pivoting motion from the negative first main-cut angle −α₁ into the negative second main-cut angle −α₂ is performed in one step and the pivoting motion from the negative second main-cut angle −α₂ into the negative third main-cut angle −α₃ in two steps; alternately, the pivoting motion into the negative second main-cut angle −α₂ can be performed in multiple steps or the pivoting motion into the negative third main cut −α₃ in one step. The decision on how many steps are needed depends on, among other things, the specification of the saw blade, the hardness of the material, and the power and torque of the drive motor for the saw blade. The intermediate angles can be set by the operator or the control unit of the wall saw system can set the intermediate angles depending on various limiting conditions. In the invented method, the main-cut angle of the main cuts and possible intermediate angles are an input parameter used to control the wall saw.

Saw head 14 is positioned before the pivoting motion of saw arm 17 into the first intermediate angle −β₁. Since the positioning takes place at obstacle E₁ and the first intermediate angle −β₁ is larger than −90°, it is not possible to position saw head 14 in such a way that the second blade guard edge 72 borders the obstacle E₁ after the pivoting motion into the first intermediate angle −β₁. Saw head 14 is positioned using the critical angle α_{crit} of −90° (FIG. 5F) and saw arm 17 is then pivoted into the first intermediate angle −β₁ (FIG. 5G). At the critical angle α_{crit} of −90°, the swivel axis 23 is a distance from the first end point of E₁ of B/2−δ·sin(−90°=B/2+δ. The critical angle α_{crit} of −90° must be taken into account because the first end point E₁ may not be overrun during the pivoting motion.

After the pivoting motion of saw arm 17 into the first intermediate angle −β₁, saw blade 16 performs clearance cutting. To do this, saw head 14 is moved in the positive feed direction 56 with saw arm 17 tilted at the first intermediate angle −β₁ and the rotating saw blade 16 for a path length of \sqrt{[h₃·}(D₃−h₃)] (FIG. 5H), where

$${h}_{3} = h ( - {α}_{3} , {D}_{3} ) = \frac{{D}_{3}}{2} - Δ - δ \cdot cos ( - 180 ° ) = \frac{{D}_{3}}{2} - Δ + δ$$

describes the penetration depth of saw blade 16 into the workpiece 24 for the negative third main-cut angle −α₃ with the third diameter D₃, which corresponds to the saw blade diameter D.

Saw head 14 is moved in the negative feed direction 57 towards the first end point E₁, The feed motion of saw head 14 is stopped when the swivel axis 23 is a distance from the first end point E₁ of B/2−δ·sin(−β₁), In this position, the first blade guard edge 71 of the blade guard 21 borders the obstacle at the first end point E₁ (FIG. 5I). Then saw head 14 is positioned using the critical angle α_{crit} of −90° in the feed direction 28 (FIG. 5J) and the saw arm 17 is pivoted from the first intermediate angle −β₁ into the negative third main-cut angle −α₃ (FIG. 5K).

In an alternative embodiment, the process steps in FIG. 5I and FIG. 5J can be combined. Saw head 14 is moved in the negative feed direction 57 towards the first end point E₁ and the feed motion of saw head 14 is stopped when the swivel axis 23 is a distance from the first end point E₁ of B/2−δ·sin(−β₁). In this position, the saw arm 17 is pivoted out of the first intermediate angle −β₁ into the negative third main-cut angle −α₃.

Since the third main cut is the final main cut in the main-cut sequence, it is advantageous to process the corners of the first end point E₁ before processing the final main cut. To do this, saw head. 1.4 is moved in the negative feed direction 57 with saw arm 17 tilted to −α₃ until the first blade guard edge 71 of the blade guard 21 borders on the obstacle at the first end point E₁ (FIG. 5L), The corner processing of the first end point E₁ can be improved if blade guard 21 is disassembled and the corner processing is performed without a blade guard. Saw head 14 is moved in the negative feed direction 57 with saw arm 17 tilted to −α₃ and without a blade guard until the first saw blade edge 61 of the saw blade 16 coincides with the first end point E₁.

If the material of workpiece 24 is hard or the power of drive motor 18 is low, the corner processing at obstacle E₁ can also be executed in multiple steps with intermediate angles. In this case, saw arm 17 is moved into a starting position after the pivoting motion into the third pivoting angle −α₃ and pivoted into the first intermediate angle while in the starting position. The starting position is calculated such that the pivoting motion takes place into all intermediate angles of the corner processing before the first end point E₁ and the first end point E₁ is not overrun. With saw arm 17 tilted to the first intermediate angle, saw head 14 is moved in the negative feed direction 57 until the swivel axis 23 is a distance to the first end point E₁ of B/2 and the first blade guard edge 71 borders on obstacle E₁. Then saw head 14 is returned to the starting position, saw arm 17 is pivoted into the next intermediate angle, and saw head 14 is moved in the negative feed direction 57 with the tilted saw arm 17 until the first blade guard edge 71 borders on the obstacle E₁. These process steps are repeated until saw head 14, with saw arm 17 tilted to the third pivoting angle −α₃, is configured in a position such that the first blade guard edge 71 borders the obstacle E₁. Corner processing in multiple intermediate steps can also be performed without a blade guard 21.

After the corner processing of the first end point E₁, the third partial cut is executed with saw arm 17 tilted to the negative third pivoting angle −α₃ in the positive feed direction 56 (FIG. 5M). The feed motion of saw head. 14 is stopped when the swivel axis 23 is a distance to the second end point E₂ of \sqrt{[h₃·}(D₃−h₃)]+δ·sin(−α₁), where

$${h}_{3} = h ( - {α}_{3} , {D}_{3} ) = \frac{{D}_{3}}{2} - Δ - δ \cdot cos ( - 180 ° )$$

describes the penetration depth of the saw blade 16 into the workpiece 24 for the negative third pivoting angle −α₃ with the third diameter D₃, which corresponds to the saw blade diameter D.

If an overlap is allowed at the second end point E₂, corner processing of the second end point E₂ (FIG. 5N) is advantageous after the third partial cut. If the material of workpiece 24 is hard or the power of drive motor 18 is low, the corner processing at the second end point E₂ can also be executed in multiple steps with intermediate angles. In this case, saw arm 17 is moved into a starting position after the end of the third partial cut and pivoted into the first intermediate angle while in the starting position. The starting position is calculated such that the pivoting motion takes place into all intermediate angles of the corner processing before the second end point E₂ and the first end point E₂ is not overrun. With saw arm 17 tilted to the first intermediate angle, saw head 14 is moved in the positive feed direction 56 until the second upper exit point 59 of saw blade 16 has reached an end position; in the end position, the second upper end point 59 is a distance from the second end point E₂ of \sqrt{[h₃}(D−h₃))−\sqrt{(Δh)·}(D−Δh)]. Here,

$${h}_{3} = h ( - {α}_{3} , D ) = \frac{D}{2} - Δ - δ \cdot cos ( - {α}_{3} )$$

describes the penetration depth of the saw blade 16 into the workpiece 24 for the negative third pivoting angle −α₃ and Δh=h₃−T the difference between the penetration depth h₃ and the final depth T. Then saw head 14 is returned to the starting position, saw arm 17 is pivoted into the next intermediate angle, and saw head 14 is moved in the positive feed direction 56 into the end position with saw arm 17 tilted. These process steps are repeated until saw head 14 is configured in the end position with saw arm 17 tilted to the third pivoting angle −α₃.

1.-25. (canceled)

26. A method for controlling a wall saw system, wherein the wall saw system comprises a guide rail and a wall saw with a saw head, a motorized feed unit that moves the saw head along the guide rail parallel to a feed direction, at least one saw blade attached to a saw arm of the saw head that is pivotable around a swivel axis and is driven around a fulcrum, and at least one detachable blade guard enclosing the saw blade;
and comprising the steps of:
creating a separating cut of a final depth (T) in a workpiece of workpiece thickness (d) between a first end point (E₁) and a second end point (E₂);
wherein before a start of a processing of the separating cut controlled by a control unit of the wall saw, at least a saw blade diameter (D) of the saw blade, positions of the first and second end points (E₁, E₂) in the feed direction (28), the final depth (T) of the separating cut, and a main-cut sequence of m main cuts, m≧2, is determined;
wherein the main-cut sequence comprises at least one first main cut with one first main-cut angle (α₁) of the saw arm and a first diameter (D₁) of the saw blade used for the first main cut and a subsequent second main cut with a second main-cut angle (α₂) of the saw arm and a second diameter (D₂) of the saw blade used for the second main cut;
wherein during the processing controlled by the control unit:
the saw arm is configured in a negative rotational direction at a negative first pivoting angle (−α₁); and
the saw head is moved in a positive feed direction in a direction of the second end point (E₂), with the saw arm in a pulling configuration;
wherein the saw head is moved during the processing controlled by the control unit such that a second boundary of the wall saw, facing the second end point (E₂), coincides with the second end point (E₂), where the second boundary of the wall saw is formed by a second upper exit point of the saw blade, facing the second end point (E₂), on the top side of the workpiece, if the second end point (E₂) does not form an obstacle, by a second saw blade edge of the saw blade, facing the second end point (E₂), if the second end point (E₂) does form an obstacle and processing is performed without a blade guard, and by a second blade guard edge of the blade guard, facing the second end point (E₂), if the second end point (E₂) forms an obstacle and processing is performed with a blade guard.

27. The method according to claim 26, wherein before the start of processing controlled by the control unit, a saw arm length (δ) of the saw arm, defined as a distance between the swivel axis and the fulcrum, and a distance (Δ) between the swivel axis and the top side of the workpiece are additionally determined.

28. The method according to claim 27, wherein before the start of the controlled processing, a first width (B₁) for a blade guard used for the first main cut and a second width (B₂) for a blade guard used for the second main cut, wherein the first and second widths (B₁, B₂) are each comprised of the first distance (B₁ₐ, B₂ₐ) from the fulcrum to the first blade guard edge and a second distance (B_{1b}, B_{2b}) from the fulcrum to the second blade guard edge.

29. The method according to claim 27, wherein the second upper exit point of the saw blade used coincides with the second end point (E₂) when the swivel axis is a distance from the second end point (E₂) of \sqrt{[h₁·}(D₁−h₁)]+δ·sin(−α₁), where
$${h}_{1} = h ( - {α}_{1} ) = \frac{{D}_{1}}{2} - Δ - δ \cdot cos ( - {α}_{1} )$$
describes a penetration depth of the saw blade being used into the workpiece for the negative first main-cut angle (−α₁), the second saw blade edge of the saw blade being used coincides with the second end point (E₂) when the swivel axis is a distance from the second end point (E₂) of
$$\frac{{D}_{1}}{2} + δ \cdot sin ( - {α}_{1} ) ,$$
and the second blade guard edge of the blade guard being used coincides with the second end point (E₂) when the swivel axis is a distance from the second end point (E₂) of B_{1b}+δ sin(−α₁).

30. The method according to claim 29, wherein the saw head is positioned in a negative feed direction opposite to the positive feed direction such that the second boundary of the wall saw coincides with the second end point (E₂) after the pivoting motion of the saw arm into the negative second main-cut angle (−α₂).

31. The method according to claim 30, wherein after the pivoting motion of the saw arm into the negative second main-cut angle (−α₂), the second upper exit point of the saw blade being used coincides with the second end point (E₂) when the swivel axis is a distance from the second end point (E₂) of \sqrt{[h₂·}(D₂−h₂)]+δ sin(−α₂), where
$${h}_{2} = h ( - {α}_{2} ) = \frac{{D}_{2}}{2} - Δ - δ \cdot cos ( - {α}_{2} )$$
describes the penetration depth of the saw blade being used into the workpiece for the negative second main-cut angle (−α₂), the second saw blade edge of the saw blade being used coincides with the second end point (E₂) when the swivel axis is a distance from the second end point
$$( {E}_{2} ) of \frac{{D}_{2}}{2} + δ \cdot sin ( - {α}_{2} ) ,$$
and the second blade guard edge of the blade guard being used coincides with the second end point (E₂) when the swivel axis is a distance from the second end point (E₂) of B_{2b}+δ·sin(−α₂).

32. The method according to claim 31, wherein during controlled processing the saw head is moved such that a first boundary of the wall saw, facing the first end point (E₁), coincides with the first end point (E₁), where the first boundary is formed by a first upper exit point of the saw blade being used, facing the first end point (E₁) on the top side of the workpiece, if the first end point (E₁) does not form an obstacle, by a first saw blade edge of the saw blade being used, facing the first end point (E₁), if the first end point (E₁) does form an obstacle and processing is performed without a blade guard, and by a first blade guard edge of the blade guard being used, facing the first end point (E₁), if the first end point (E₁) does form an obstacle and processing is performed with a blade guard.

33. The method according to claim 32, wherein the main-cut sequence has a third main cut subsequent to the second main cut with a third main-cut angle (α₃) of the saw arm, a third diameter (D₃), and a third width (B₃) with a first and second distance (B₃ₐ, B_{3b}), where the saw arm is in a pulling configuration for the third main cut and the saw head is moved in the positive feed direction.

34. The method according to claim 33, wherein the saw head is positioned in the positive feed direction such that the first boundary of the wall saw coincides with the first end point (E₁) after the pivoting motion of the saw arm into the negative third main-cut angle (−α₃).

35. The method according to claim 34, wherein after the pivoting motion of the saw arm into the negative third main-cut angle (−α₃), the first upper exit point of the saw blade used coincides with the first end point (E₁) when the swivel axis is a distance from the first end point (E₁) of \sqrt{[h₃·}(D₃−h₃)]−δ·sin (−α₃), where
$${h}_{3} = h ( - {α}_{3} ) = \frac{{D}_{3}}{2} - Δ - δ \cdot cos ( - {α}_{3} )$$
describes the penetration depth of the saw blade being used into the workpiece for the negative third main-cut angle (−α₃), the first saw blade edge of the saw blade being used coincides with the first end point (E₁) when the swivel axis is a distance from the first end point (E₁) of
$$\frac{{D}_{3}}{2} - δ \cdot sin ( - {α}_{3} ) ,$$
and the first blade guard edge of the blade guard being used coincides with the first end point (E₁) when the swivel axis is a distance from the first end point of B₃ₐ−δ·sin(−α₃).

36. The method according to claim 26, wherein the first and the second main cut are executed with one saw blade and one blade guard.

37. The method according to claim 26, wherein the first main cut is executed by a first saw blade and a first blade guard, with the first saw blade having a first saw blade diameter (D.1) and the first blade guard having a first blade guard width (B.1), and the second main cut is executed with a second saw blade and a second blade guard, with the second saw blade having a second saw blade diameter (D.2) and the second blade guard having a second blade guard width (B.2).

38. The method according to claim 26, wherein the first main cut of the main-cut sequence is a pre-cut and, after the start of processing controlled by the control unit, the saw head is positioned parallel to the feed direction in a start position (X_{Start}), where in the start position (Xₛₜₐᵣₜ) the first end point (E₁)-facing first boundary of the wall saw coincides with the first end point (E₁) after the pivoting motion into the negative first main-cut angle (−α₁), where the first boundary of the wall saw is formed by the first upper exit point of the saw blade being used on the top side of the workpiece if the first end point (E₁) does not form an obstacle, by the first saw blade edge of the saw blade being used if the first end point (E₁) does form an obstacle and processing is performed without a blade guard, and by the first blade guard edge of the blade guard being used if the first end point (E₁) does form an obstacle and processing is performed with a blade guard.

39. The method according to claim 38, wherein in the start position (X_{Start}) the first upper exit point coincides with the first end point (E₁) when the swivel axis is a distance from the first end point (E₁) of \sqrt{[h₁·}(D₁−h₁)]−δ·sin (−α₁), where
$${h}_{1} = h ( - {α}_{1} , {D}_{1} ) = \frac{{D}_{1}}{2} - Δ - δ cos ( - {α}_{1} )$$
describes the penetration depth of the saw blade being used into the workpiece for the negative first main-cut angle (−α₁), the first saw blade edge of the saw blade being used coincides with the first end point (E₁) when the swivel axis is a distance from the first end point (E₁) of
$$\frac{{D}_{1}}{2} - δ sin ( - {α}_{1} ) ,$$
and the first blade guard edge of the blade guard being used coincides with the first end point (E₁) when the swivel axis is a distance from the first end point (E₁) of B_{1α}−δ·sin(−α₁).

40. The method according to claim 39, wherein saw head is moved in the positive feed direction with the saw arm tilted to the negative first main-cut angle (−α₁).

41. The method according to claim 26, wherein the main-cut sequence includes a pre-cut to be performed before the first main cut with a zeroth main-cut angle (α₀) of the saw arm, a zeroth diameter (D₀), and a zeroth width (B₀) with a first and second distance (B₀ₐ, B_{0b}), with the saw arm configured in a pulling configuration for the pre-cut and the saw head moving in the negative feed direction.

42. The method according to claim 41, wherein, after the start of processing controlled by the control unit, the saw head is positioned for the pre-cut parallel to the feed direction in a start position (X_{Start}), where in the start position (X_{Start}) the second end point (E₂)-facing second boundary of the wall saw coincides with the second end point (E₂) after the pivoting motion into the positive zeroth main-cut angle (+α₀).

43. The method according to claim 42, wherein, after the pivoting motion into the positive zeroth main-cut angle (+α₀), the second upper exit point of the saw blade being used coincides with the second end point (E₂) when the swivel axis is a distance from the second end point (E₂) of \sqrt{[h₀·}(D₀−h₀)]+δ·sin (+α₀), where
$${h}_{0} = h ( + {α}_{0} , {D}_{0} ) = \frac{{D}_{0}}{2} - Δ - δ \cdot cos ( + {α}_{0} )$$
describes the penetration depth of the saw blade being used into the workpiece for the positive zeroth main-cut angle (+α₀), the second saw blade edge of the saw blade being used coincides with the second end point (E₂) when the swivel axis is a distance from the second end point (E₂) of
$$\frac{{D}_{0}}{2} + δ .$$
sin(+α₀), and the second blade guard edge of the blade guard being used coincides with the second end point (E₂) when the swivel axis is a distance from the second end point (E₂) of B_{0b}+δ·sin(+α₀).

44. The method according to claim 43, wherein the saw arm is moved in the negative feed direction with the saw arm tilted to the positive zeroth main-cut angle (+α₀).

45. The method according to claim 44, wherein the saw head is moved such that the first boundary of the wall saw coincides with the first end point (E₁), where the first boundary of the wall saw is formed by the first upper exit point of the saw blade being used on the top side of the workpiece if the first end point (E₁) does not form an obstacle, by the first saw blade edge of the saw blade being used if the first end point (E₁) does form an obstacle and processing is performed without a blade guard, and by the first blade guard edge of the blade guard being used if the first end point (E₁) does form an obstacle and processing is performed with a blade guard.

46. The method according to claim 45, wherein the first upper exit point of the saw blade being used coincides with the first end point (E₁) if the swivel axis is a distance from the first end point (E₁) of \sqrt{[h₀·}(D₀−h₀)]−δ·sin (+α₀), where
$${h}_{0} = h ( + {α}_{0} , {D}_{0} ) = \frac{{D}_{0}}{2} - Δ - δ \cdot cos ( + {α}_{0} )$$
describes the penetration depth of the saw blade being used into the workpiece for the positive zeroth main-cut angle (+α₀), the first saw blade edge of the saw blade being used coincides with the first end point (E₁) when the swivel axis is a distance from the first end point
$$( {E}_{1} ) of \frac{{D}_{0}}{2} - δ \cdot sin ( + {α}_{0} ) ,$$
and the first blade guard edge of the blade guard being used coincides with the first end point (E₁) when the swivel axis is a distance from the first end point (E₁) of B_{0α}−δ·sin(α₀).

47. The method according to claim 44, wherein the saw head is moved such that after the pivoting motion of the saw arm into the negative zeroth main-cut angle (−α₀), the first boundary of the wall saw coincides with the first end point (E₁), where the first upper exit point of the saw blade being used coincides with the first end point (E₁) when the swivel axis is a distance from the first end point (E₁) of \sqrt{[h₀·}(D₀−h₀)]−δ sin(−α₀), where
$${h}_{0} = h ( - {α}_{0} , {D}_{0} ) = \frac{{D}_{0}}{2} - Δ - δ \cdot cos ( - {α}_{0} )$$
describes the penetration depth of the saw blade being used into the workpiece for the negative zeroth main-cut angle (−α₀), the first saw blade edge of the saw blade being used coincides with the first end point (E₁) when the swivel axis is a distance from the first end point (E₁) of
$$\frac{{D}_{0}}{2} - δ \cdot sin ( - {α}_{0} ) ,$$
and the first blade guard edge of the blade guard being used coincides with the first end point (E₁) when the swivel axis is a distance from the first end point (E₁) of B_{0α}−δ·sin(−α₀).

48. The method according to claim 47, wherein the saw head is moved in the positive feed direction by a path length of at least 2δ| sin(−α₀)| and the saw head is then positioned such that the first boundary of the wall saw coincides with the first end point (E₁) after the pivoting motion of the saw arm into the negative first main-cut angle (−α₁), where the first upper exit point of the saw blade being used coincides with the first end point (E₁) when the swivel axis is a distance from the first end point (E₁) of \sqrt{[h₁·}(D₁−h₁)]−δ sin(−α₁), where
$${h}_{1} = h ( - {α}_{1} , {D}_{1} ) = \frac{{D}_{1}}{2} - Δ - δ \cdot cos ( - {α}_{1} )$$
describes the penetration depth of the saw blade being used into the workpiece for the negative first main-cut angle (−α₁) with the first diameter (D₁), the first saw blade edge of the saw blade being used coincides with the first end point (E₁) when the swivel axis is a distance from the first end point (E₁) of
$$\frac{{D}_{1}}{2} + δ \cdot sin ( - {α}_{1} ) ,$$
and the first blade guard edge of the blade guard being used coincides with the first end point (E₁) when the swivel axis is a distance from the first end point (E₁) of B_{1α}+δ·sin(−α₁).

49. The method according to claim 47, wherein the saw head is moved in the positive feed direction such that the first boundary of the wall saw coincides with the first end point (E₁) after the pivoting motion of the saw arm into the negative first main-cut angle (−α₁), where the first upper exit point of the saw blade being used coincides with the first end point (E₁) when the swivel axis is a distance from the first end point (E₁) of \sqrt{[h₁·}(D₁−h₁)]+δ sin (−α₁), where
$${h}_{1} = h ( - {α}_{1} , {D}_{1} ) = \frac{{D}_{1}}{2} - Δ - δ \cdot cos ( - {α}_{1} )$$
describes the penetration depth of the saw blade being used into the workpiece for the negative first main-cut angle (−α₁) with the first diameter (D₁), the first saw blade edge of the saw blade being used coincides with the first end point (E₁) when the swivel axis is a distance from the first end point (E₁) of
$$\frac{{D}_{1}}{2} - δ \cdot sin ( - {α}_{1} ) ,$$
and the first blade guard edge of the blade guard being used coincides with the first end point (E₁) when the swivel axis is a distance from the first end point (E₁) of B_{1α}−δ·sin(−α₁).

50. The method according to claim 44, wherein the saw head is moved such that, after the pivoting motion of the saw arm into the negative first main-cut angle (−α₁), the first boundary of the wall saw coincides with the first end point (E₁), where the first upper exit point of the saw blade being used coincides with the first end point (E₁) when the swivel axis is a distance from the first end point (E₁) of \sqrt{[h₁·}(D₁−h₁)]−δ sin(−α₁), where
$${h}_{1} = h ( - {α}_{1} , {D}_{1} ) = \frac{{D}_{1}}{2} - Δ - δ \cdot cos ( - {α}_{1} )$$
describes the penetration depth of the saw blade being used into the workpiece for the negative first main-cut angle (−α₁), the first saw blade edge of the saw blade being used coincides with the first end point (E₁) when the swivel axis is a distance from the first end point (E₁) of
$$\frac{{D}_{1}}{2} - δ \cdot sin ( - {α}_{1} ) ,$$
and the first blade guard edge of the blade guard being used coincides with the first end point (E₁) when the swivel axis is a distance from the first end point (E₁) of B_{1α}−δ·sin(−α₁).
